(19) United States
(12) Patent Application Publication
(10) Pub. No.: US 2013/0345602 A1
(43) Pub. Date: Dec. 26, 2013

(54) PHYSICAL THERAPY DEVICE APPLYING MULTIPLE RELAXATION PROCESSES

(71) Applicants: Hon Hai Precision Industry Co., Ltd., New Taipei (TW); Hong Fu Jin Precision Industry (ShenZhen) Co., Ltd., Shenzhen (CN)

(72) Inventor: YONG-SHENG YANG, Shenzhen (CN)

(21) Appl. No.: 13/922,284

(22) Filed: Jun. 20, 2013

(30) Foreign Application Priority Data
Jun. 20, 2012 (CN) 2012102046392

(51) Int. Cl. A61H 23/00

(52) U.S. Cl. CPC A61H 23/00
USPC 601/15; 601/1; 601/57

(57) ABSTRACT

A therapy device includes a chair, a helmet, and a number of programmable relaxing processes carried out on a passive user. The helmet is pivotally connected to the chair and can provide music and an eye massage. The device also applies an automatic back massage. These relaxing processes, to relieve fatigue in a user, can be started and finished automatically and run for any selected period.

### 1. TECHNICAL FIELD

The disclosure generally relates to medicine and recreational equipment, and particularly, to a therapy device for relaxing people.

### 2. DESCRIPTION OF RELATED ART

Ordinary chairs provide support for people sitting down, but fail to provide more services to relax people when they sit on the chairs. Thus, ordinary chairs may not necessarily relieve fatigue.

Therefore, it is desirable to provide a means which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of a therapy device in accordance with an exemplary embodiment of the present disclosure, wherein the therapy device includes a helmet.

FIG. 2 is an isometric view of the helmet of FIG. 1, showing an interior structure of the helmet.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

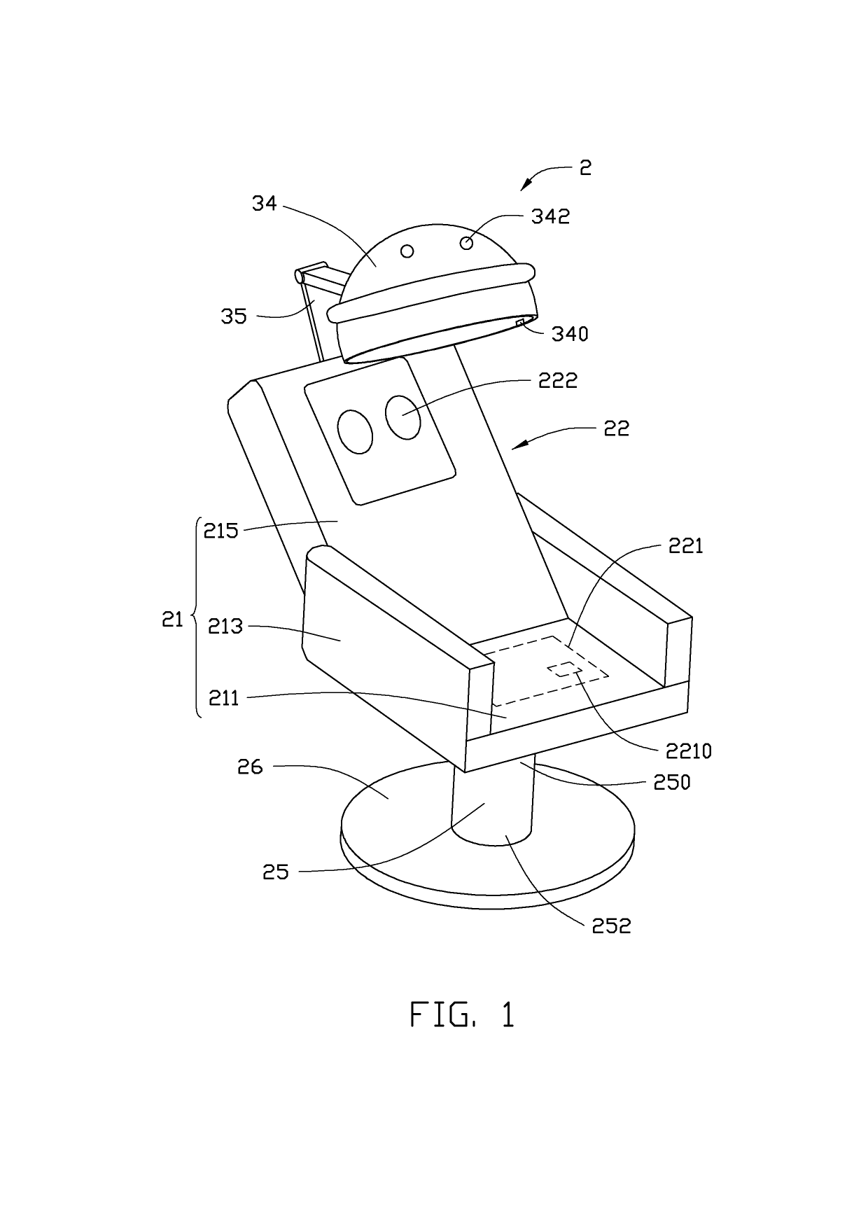

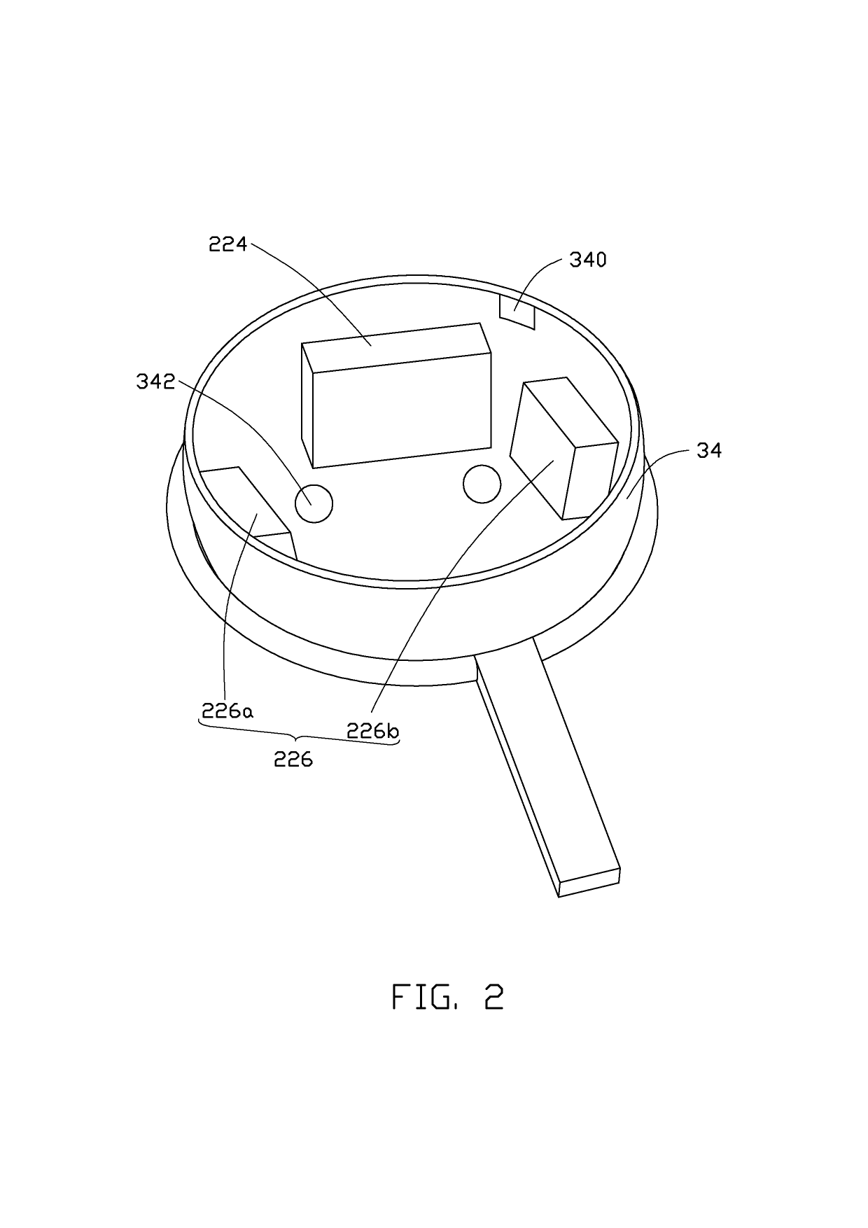

Referring to FIGS. 1 and 2, in one embodiment, a therapy device 2 includes a base 26, a rotation regulator 25, a chair 21, and a number of different items of relaxing equipment 22. The chair 21 is rotatably connected to the base 26. The items of relaxing equipment 22 are set on the chair 21 to relax a user sitting on the chair 21.

The rotation regulator 25 is substantially a cylindrical post, and includes a first connecting end 250 and a second connecting end 252 opposite to the first connecting end 250. The first connecting end 250 is connected to the base 26. The second connecting end 252 is connected to the chair 21. In this embodiment, the rotation regulator 25 is rotatably connected to the base 26 via the first connecting end 250, and the chair 21 is driven to rotate about the base 26 by the rotation regulator 25. In another embodiment, the first connecting end 250 is fixed to the base 26, and the chair 21 is rotatably connected to the second connecting end 252.

The chair 21 includes a holding board 211, a pair of armrests 213, a backboard 215, a connecting arm 35, and a helmet 34. The holding board 211 holds the user sitting on the chair 21. The armrests 213 are mounted to opposite sides of the holding board 211. The backboard 215 is rotatably connected to the holding board 211 to support the back of a user, and is located between and behind the armrests 213. The helmet 34 is pivotally connected to an end of the backboard 215 far from the holding board 211 via the connecting arm 35. Thus, a position of the helmet 34 can be adjusted relative to the backboard 215. In this embodiment, the helmet 34 covers most of the head of the user.

The items of relaxing equipment 22 are configured to automatically provide various relaxing services at the same time to a person sitting on the chair 21. The items of relaxing equipment 22 may be, but are not limited to, a vibrator 221, a back massager 222, an eye massager 224, and an audio player 226. The vibrator 221 is set in the holding board 211 and includes a timer 2210. The timer 2210 starts to time when the pressure applied on the holding board 211 is greater than a predetermined value. The vibrator 221 reminds the user on the holding board 211 of the passing of time by executing a vibration at predetermined time intervals. That is, the vibrator 221 is programmable to achieve the above-described functions and characteristics.

The back massager 222 is set in the backboard 215 to massage the user on the holding board 211 according to certain predetermined situations. The predetermined situations may be, but are not limited to, the user touching or leaning against the backboard 215. For example, when the user touches or leans against the backboard 215, the back massager 222 starts to massage the user. The back massager 222 continues to operate even after the user passively remains in position leaning against the backboard 215. The back massager 222 may also start to massage the user when the vibrator 221 transmits a start signal to the back massager 222 once in every predetermined time interval. That is, the back massager 222 is programmable to achieve the above-described functions and characteristics, and can be electrically connected to the vibrator 221.

The eye massager 224 and the audio player 226 are set on an inner surface of the helmet 34. The eye massager 224 is located at a front side of the helmet 34. The audio player 226 includes at least two loudspeakers 226a, 226b set beside the eye massager 224. The eye massager 224 massages the eyes of the user when the user's head is inserted into the helmet 34. The audio player 226 plays music to relax the user when the eye massager 224 executes the massaging action. The helmet 34 includes a sensor 340 to detect whether the head of the user is inserted into the helmet 34. The sensor 340 can for example be an optical sensor. The helmet 34 defines a number of through holes 342 therein to allow air to circulate and cool the user. The helmet 34 can be made of a transparent material, such as glass. The helmet 34 also can be made of a non-transparent material, such as metal or plastic.

In use, the user sits on the holding board 211 and leans his back on the backboard 215. The back massager 222 massages the back of the user when the user's back leans on the backboard 215. The user puts his/her head into the helmet 34. The eye massager 224 massages the eyes of the user and the audio player 226 plays music when the sensor 340 detects the presence of the head of the user in the helmet 34. Therefore, the user can enjoy different relaxation services at the same time when he/she sits on the chair 21.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A therapy device to relieve fatigue of people, comprising:
a chair;
a helmet pivotally connected to the chair; and
a plurality of different items of relaxing equipment set in at least one of the chair and the helmet and configured to automatically provide various relaxing services at the same time to a human user sitting on the chair.

2. The therapy device of claim 1, wherein the chair comprises a holding board, a pair of armrests mounted to a pair of opposite sides of the holding board, and a backboard rotatably connected to the holding board, the backboard is located between and behind the armrests, and the helmet is pivotally connected to an end of the backboard far from the holding board.

3. The therapy device of claim 2, wherein one of the items of relaxing equipment is a vibrator set in the holding board, the vibrator comprises a timer, the timer start to time when an applied external pressure on the holding board is greater than a predetermined value, and the vibrator reminds the user on the holding board of the passing time by executing a vibration at predetermined time intervals.

4. The therapy device of claim 3, wherein another one of the items of relaxing equipment is a back massager set in the backboard to massage the user on the holding board.

5. The therapy device of claim 4, wherein the back massager is configured to start to massage the user when the user leans against the backboard.

6. The therapy device of claim 4, wherein the back massager is electrically connected to the vibrator, and starts to massage the user when the vibrator transmits a start signal to the back massager once in every predetermined time interval.

7. The therapy device of claim 2, wherein one of the items of relaxing equipment is an eye massager set on an inner surface of the helmet, and the eye massager is located at a front side of the helmet.

8. The therapy device of claim 7, wherein another one of the items of relaxing equipment is an audio player, and the audio player includes at least two loudspeakers correspondingly set beside the eye massager.

9. The therapy device of claim 8, wherein the helmet comprises a sensor to detect whether a head of the user is inserted into the helmet, the eye massager is configured to start to massage the eyes of the user when the sensor detects the presence of the head of the user in the helmet, and the audio player is configured to play music to relax the user when the eye massager executes the massaging.

10. The therapy device of claim 1, wherein the helmet defines a plurality of through holes therein to allow air to circulate and cool the user.

11. The therapy device of claim 1, wherein the helmet is made of transparent material.

12. The therapy device of claim 1, wherein the helmet is made of non-transparent material.

13. The therapy device of claim 1, further comprising a base and a rotation regulator, wherein the chair is rotatably connected to the base via the rotation regulator.

14. The therapy device of claim 13, wherein the rotation regulator is substantially a cylindrical post, the chair is fixed to an end of the rotation regulator, and the other end of the rotation regulator far from the chair is rotatably connected to the base.

15. The therapy device of claim 13, wherein the rotation regulator is substantially a cylindrical post, the chair is rotatably connected to an end of the rotation regulator, and the other end of the rotation regulator is fixed to the base.
